(19) United States
(12) Patent Application Publication
(10) Pub. No.: US 2008/0189138 A1
(43) Pub. Date: Aug. 7, 2008

(54) AUDIO CONTROL POINT OF CARE MANAGEMENT SYSTEM

(76) Inventor: Johnny S. Yuen, Cary, NC (US)

Correspondence Address: PASSE' INTELLECTUAL PROPERTY, LLC, 1717 BRASSFIELD RD., RALEIGH, NC, 27614, US

(21) Appl. No.: 11/671,983

(22) Filed: Feb. 6, 2007

(51) Int. Cl. G06Q 50/00

(52) U.S. Cl. 705/3

(57) ABSTRACT

The present invention relates to a point of care management system for delivering audio instructions to selected healthcare workers in a clinical organization. The healthcare worker receives the audio instructions via a hand held computer such as a PDA with an audio headset. Further, the present invention calculates and delivers treatment instructions at selected time with follow up and query capabilities.

### BACKGROUND OF THE INVENTION

1. Field of the Invention

The present invention relates to a method of providing patient point of care treatment with interactive voice and data control. In particular, the present invention relates to use of a computer system with voice commands to hand held computers to control the activities of a healthcare worker in providing patient treatment modalities as well as recording activities in real time and taking requests and inputs from healthcare workers through speech.

2. Description of the Related Art

Computer information systems are well known and include various configurations including single computers and multiple computers that communicate with each other over networks, hard wire or wirelessly. They have been used by healthcare organizations to manage data and medical information about patients their treatment and the like. These systems have been a great advance over old manual systems which were slow time consuming, expensive, error prone and extremely poor at providing any kind of global analysis of the whole system.

The advent of computer information systems had lead to a plethora of uses for improving the management of the various aspects of medical information. In U.S. Pat. No. 6,321,203 there is described a medical care schedule and record aiding system along with a method of using the system. The system generates output in the format of a table which can be used to manage a patient load and medical care actions. The system is designed for general management and not designed to be applied to a single healthcare worker or patient.

In U.S. Pat. No. 6,983,423 there is described an electronic system for collection and communication clinical order information in an acute care setting. Here again a graphic user interface for use on a client computer is described with appropriate order entry and navigational systems are described in detail. The system is described as providing uses with decision support tools and features triggered by opening an order.

Use of computer systems to monitor and manage medication delivery has also been the subject of much work. In U.S. Pat. No. 6,985,870 there is described a medication delivery system. This particular system appears capable of communicating and matching prescribed medication data to a medication container having a data port for receiving medication data. In yet another medication system, U.S. Pat. No. 7,107,106 describes a system and method for collection of data and managing patient care automatically by administering medication to a patient. In this system, medication is delivered via infusion pumps and controlled via numerous computer stations attached to a central computer. Bar-coded patient identifiers are used in this system to control identification of the correct patient during the medication process.

In order to input patient parameters a number of approaches have been used. One in particular involves point of care stations for managing patient information that comprise computer terminals. In U.S. Pat. No. 7,038,588 there is a computer system with a stand that includes various features such as cameras, recording devices and the like. While these stations are mobile they are far from either hand-held or capable of being carried around with the healthcare worker. These devices can be left next to the patient and moved but, because of their size are not designed for continuous hand-held use. Likewise, in Published Patent Application No 2006/0125356 there is disclosed a mobile point of care computer and program system. Once again a small computer (not hand-held) with a portable cart is disclosed. But again it is designed as a point of care cart to be placed near a patient and left rather than kept with a healthcare worker between uses. These larger carts include self identification means which aids in finding the cart between uses. Another example of this approach is in published application 2006/0173246 where there is described a medical information interface and communication system. The system process patient medical parameter data for presentation to a user on a display.

Accordingly, point of care devices and methods are varied and involve data input and management. While many of them could be used together to improve point of care, currently, unless the health care worker is sitting at the point of care screen or patient side at the time that patient treatment is due there is no way for the worker to automatically know it is time to administer a particular treatment. Therefore, there is a need for a system and method to directly notify and interact with the healthcare professional at all times while that worker is involved in the routine administration of their job to insure that the worker administers patient treatment at the proper time and to the proper patient.

### SUMMARY OF THE INVENTION

It has been discovered in the present invention, a system for point of care treatment where the health care worker can be conveniently brought to the patient at the appropriate time and place and conveniently feed back the point of care service to insure proper administration of the service.

In one aspect the invention relates to a point-of-care system for delivering systematic patient treatment by one or more healthcare workers wherein each healthcare worker is assigned to providing treatment to a selected one or more patients comprising:
a. one or more wireless handheld computers capable of receiving audio communication wherein each of said handheld computers is designed to be assigned to an individual healthcare worker;
b. a text to speech system; and
c. a central computer system capable of acquiring data or processing data for patient treatment parameters, and the healthcare worker assigned to administer the treatment;
d. the central computer having a first audio communication interface for communicating patient treatment parameters at a selected time with a selected computer from step a) corresponding to the healthcare worker assigned to administer the treatment parameters being communicated, and a second communication interface for receiving to the response from the healthcare worker to the communicated treatment parameters.

In another embodiment of the invention there is a method of operating an audio based wireless point of care patient treatment system comprising:
a. acquiring data on a central computer system representing patient treatment parameters; and then processing the data such that it is prepared for audio presentation to a selected healthcare worker on a wireless handheld computer;
b. transmitting the patient treatment parameters from the central computer to the handheld computer at a selected time, such that it is presented in an audio manner to the selected healthcare worker;
c. acquiring digital data on the central computer from the selected healthcare worker regarding the patient treatment parameters.

These and other objects of the present invention will be clear when taken in view of the detailed specification and disclosure in conjunction with the appended figures.

### BRIEF DESCRIPTION OF THE DRAWINGS

FIG. 1 illustrates a point-of-care audio communication management system of the invention.

FIG. 2 depicts sample audio communications from a central computer to a wireless audio handheld computer (PDA).

FIG. 3 depicts sample audio communications from a healthcare worker via a handheld computer (PDA) and the central computer.

### DETAILED DESCRIPTION OF THE INVENTION

The general description of the invention and how to use the communication means are stated in the Brief Summary above. This detailed description defines the meaning of the terms used herein and specifically describes embodiments in order for those skilled in the art to practice the invention. The above interests in communicating to responsible healthcare workers when, where, to whom, what, how much, how to administer treatment are explained and the objects of the present invention met as can be seen readily from the disclosure which follows and thus met by the present invention.

As used herein, the term “point-of care management system” refers to managing the patient treatment modalities in a patient treatment facility such as a hospital, nursing facility, hospice, critical care unit, physical therapy clinic, chiropractic clinic, medical or dental practice, or the like. It includes not only medical treatment such as medication administration, radiographs, therapy and the like but includes other medical care including clean-up, supplies, alerting, change of beds and the like. The present invention can be used stand alone or can as shown in the embodiment in the figures, be combined with other elements of previously known point-of-care systems.

As used herein, “systematic patient treatment” refers to the need for the point-of-care treatment modalities to be administered at a given time by a selected healthcare worker. In order to accomplish such systematic treatment, the assigned healthcare worker must be alerted that a treatment is now due or slightly before the treatment is due. For example, in administering a medication, an administering nurse would need to be notified sufficiently in advance, such that the medication could be obtained and the worker arrives at the patient bedside at the appropriate administration time. That time will vary from patient to patient and be determined by factors such as distance the hospital, the worker administering and the like but would be within the skill in the art. The system doing the reminding would then need to receive feedback that the treatment modality had been accomplished or if not reasons for non completion of the task. That way the system can alert other healthcare workers in the instance where a treatment is not accomplished according to the treatment regime established in the system.

As used herein the terms “healthcare workers” and “healthcare worker is assigned” refers to the fact that when a patient treatment is to be administered to a patient, there will be a particular worker or workers assigned to that task. For example, in the administration of a radiograph, a first communication to a worker may be to go to patient “A” and transfer the patient to x-ray, another communication would tell the x-ray worker to take the x-ray and yet another communication to return the patient to their bed. While this treatment is being administered another communication might be to another worker to change the linens in the patient's bed, provide clean-up or the like. It is also clear from the state of the art that a particular healthcare worker may be assigned to one or more patients and multiple healthcare workers may be assigned to a given patient within the scope of the present invention.

As used herein, “wireless handheld computers capable of transmitting and receiving audio communication” refers in general to PDA type handheld computers where they also function with either a phone, walkie-talkie, blue tooth or other two way audio communication capable of communicating with a central computer through a communication interface. In one embodiment, the computer is a PDA with a wireless or wired headset. Communication interfaces are well known for receiving audio input and converting into digital data for another computer to read.

As used herein the term “voice recognition system” refers to software that is capable of converting spoken language to text or digital format recognizable by a computer operating system on the central computer. The voice recognition system would be useful to allow a healthcare worker to respond to audio communication verbally and then the central computer convert that information to record treatment information about a patient such as treatment time, confirmation of the patient, completion of treatment and the like. Likewise as used herein “text to speech system” refers to software, programming hardware and the like designed to take patient treatment parameters and convert the instructions to audible speech to be transmitted to the wireless handheld computer. Speech, voice and commands produced by computer herein include preprogrammed computer commands and natural language processing.

As used herein the term “central computer system” refers to one or more computers that are capable of acquiring patient treatment data, patient data, healthcare worker scheduling and availability, and the like. The system is also either capable of assigning a patient treatment to a healthcare worker or is capable of having a healthcare moderator enter data for the healthcare worker or workers to be assigned to a particular treatment or backup workers, and the like. The computer in one embodiment is also capable of prioritizing treatment schedules and healthcare worker schedules in application of a point of care treatment. The central computer is also capable of assigning a priority to communications it both receives and sends out thus allowing the central computer to prioritize communications to healthcare workers using a priority sequence.

The central computer may take on a number of different versions. For example the central computer may be a single PC type computer or a server type computer. It may also be more than one computer connected to join together computing and memory power. Supercomputer type computers while not usually used for this purpose could if cost effective enough for example for a large chain of hospitals.

The central computer will also need to have certain readily available software as mentioned above but also will need certain hardware interface. As used herein a “first audio communication interface” refers to hardware (with potential software control) for taking patient treatment parameters that have been converted to speech by the text to speech system and transmitting it to the handheld computers or PDA's. Such hardware is readily available to one skilled in the art and is combined with other elements of the present invention. The first audio communication interface will be matched with other input that is processed by the computer namely time of administration, the healthcare worker that is assigned to do the work, the PDA assigned to each healthcare worker and the like, in order to interface the right patient treatment, to the right healthcare worker at the right time for administration of the treatment. Other parameters could also be introduced such as location, the route to be taken, dosage or quantity, the patient, the material and/or equipment involved.

As used herein a “second communication interface” refers to another hardware interface for the central computer. The hardware could be separate from the first communication interface but often hardware is available which does more than one interface job. The second interface would be responsible for processing and receiving input from the healthcare worker after the initial contact by the central computer. In one embodiment, this contact is audio communicated to the central computer. In another embodiment, the healthcare worker is communicating with the central computer via text, Graphic User Interface (GUI) and the like. The healthcare worker could interface with their PDA, and in one embodiment via headset which could be supplemented by soft or hard keyboard input, or in another embodiment the healthcare worker would interface using a work station interface computer, a bed-side interface, or the like.

As used herein the term “patient treatment parameters” refers to the patient or support needs to be transmitted to a healthcare worker by the present invention. These parameters include the instructions for the necessary actions to be taken by the worker. Patient treatment parameters not only includes medial procedures but also includes support functions like clean-up, moving a patient, movement of equipment, attending to general patient needs and the like. Medical procedures could include but certainly not limited to administration of medication, therapy administration, confirmation of treated patient, confirmation of medication, education material, collection of sample, emergency treatments, diagnosis and the like. Parameters may be simple single instructions or in another embodiment be a series of steps to be taken in a complex treatment. It might also give times, amounts, durations, dosages, and other quantity type parameters. Patient treatment parameters, in another embodiment, could also include requests for input from the worker such as confirmation of administration of treatment, input of vital signs, completion of movement of the patient, patient rejection of treatment and the like which could be responded back to the central computer by the worker to complete the feedback and complete the treatment cycle. In simple terms, the patient treatment parameters can include time parameters such as time to arrive, time to administer and the like as well as place, to whom, the route of administration, how much, what equipment and the like. One skilled in the art would clearly be able to formulate other patient treatment parameters in view of this disclosure.

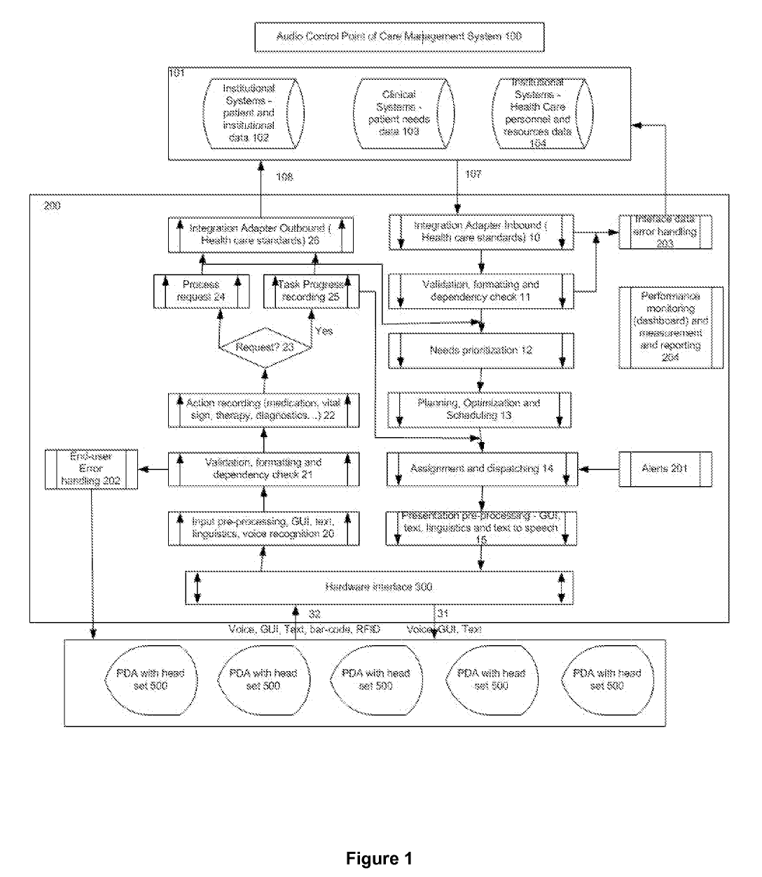

Now referring to the figures, FIG. 1 illustrates an embodiment of a point-of-care management system 100 of the present invention. Certain data must be entered into the system both initially and as the system is used. Organization input information 101 are the items within the organization input information box 101. It consists of patient and institutional data 102, patient needs (treatment and educational) data 103 and personnel and resource information data 104. The system 100 and or elements contained within the system 100 may be implemented either in a centralized or decentralized configuration. The system may be implemented as a client-server, web-based or stand-alone configuration.

Patient institutional data 102 consists of identifiers regarding the individual patients receiving patient treatment by the management system 100. The data would include items such as patient name, address, physician, reason for admission, health history, relationship to the institution, admission status, assigned room, and so forth. This data 102 is normally entered at the admissions desk and early as the patient is admitted for treatment by the institution. This data 102 is normally updated by the organization as changes to variables occur such as room changes diagnosis, treatment, variation in physicians and the like. When data is unavailable it will be supplemented by direct maintenance on Central computer 200.

The patient treatment needs 103 are normally entered after a patient is admitted to an organization or institution. After appropriate diagnoses, the physician or other institutional worker enters into the clinical system and the central computer 200, the patient treatment as described above. Also, the support information such as described above, for example, cleaning, maintaining, replacing and the like can also be entered by the appropriate staff. Treatment includes course of treatment, existence of a condition, preventative services, maintenance services, educational services and the like. When data is unavailable it will be supplemented by direct maintenance on Central computer 200.

The resource information 104 relates to data information regarding the institutions personnel and their availability or work schedule. It also includes regular duties and can further include skill sets and tasks capable of being completed. It can also include the list of who reports to whom in the institution so than appropriate personnel may be contacted for back-up contact, verification, alternate assignments, redundancy checking of treatment and other personnel that connect with the patient treatment. In addition, it could include which PDA 200 is assigned to which worker. In general the data must include enough information for the central computer system 200 to decide who to send information to regarding patient treatment.

The system 100 elements and/or processes contained therein may be implemented in hardware, software, or a combination of both, and may include one or more processors, such as the processor that controls decisions 10 through 15. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

The communication path 107 (otherwise called network, bus, link, connection, channel, etc.) represents any type of protocol or data format of the data to be received from the appropriate data entry station (102, 103 and 104). The protocol or data format includes, but is not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The central computer 200 includes both software and hardware and further includes executable applications, two-way interfaces and the like over a selected communication pathway. It consists of parts for receiving data from the information input 101, processing such information, making the information available editable and capable of checking for errors and then processing for transmission eventually and at the appropriate time to hand held computers shown as PDA with hand set 500. Necessary data storage and the like is well within the skill in the art and appropriate software and hardware is not shown for added clarity of the FIG. 1.

The central computer 200 will perform necessary processing of the data prior to assignment of a patient treatment protocol and distribution to a healthcare worker for action. Several steps of processing are shown in computer 200 but it is clear from this FIG. 1 that order or the exact processing steps could be modified as necessary for the organization and the particular treatment being considered. In the embodiment of FIG. 1, processing steps include application of healthcare standards 10, validation, formatting and dependency checking 11, needs prioritization 12, planning, optimization and scheduling treatment 13, assignment and dispatching choices 14 and presentation preprocessing for GUI, text, linguistics and text to speech 15.

At the end of the processing of the data 102, 103 and 104 by central computer 200, the processing steps 10-15 will have prepared the data into patient treatment parameters and time for administration of the patient treatment or in addition for a time to contact a healthcare worker about administration of such treatment. The presentation pre processing 15 will determine the mode or modes of transmission to the healthcare worker including text to speech to PDA 500 at that point the processing software can move the data to a hardware interface 300. Hardware interface 300 would contain necessary communication interface including a first audio interface for communicating patient treatment parameters at a selected time to a PDA 500 assigned to the appropriate healthcare worker, in an audio manner. Audio communication may be supplemented by text, or GUI communication on the handheld computer screen. In this embodiment, PDA 500 is equipped with a head set, either hard wired or wireless, such as Bluetooth technology for receiving a transmission from central computer 200. The hardware interface 300 then communicates 31 with the appropriate PDA 500, the patient treatment parameter and the time selected such that the PDA receives an audio communication of the information. This can be accomplished in a number of ways. For example the PDA could ring, requiring the worker to answer the PDA before receiving the message. In another embodiment, the PDA is set to automatically play the communication to the worker. In yet another embodiment the communication would continue to repeat at a selected intervals until the healthcare worker communicates back to the computer 200. In another embodiment not shown, the communication could be additionally sent to back-up computers (not shown) either hand held or stationary or mobile non hand held corresponding to multiple interface communication addresses. Importantly, the role the hardware interface 300 plays is to identify communication addresses of PDAs 500 and any other interface addresses to which communication by the central computer 200 is desirable such as a clinical cart, bedside terminal, department terminal or central data input/output terminal.

PDA with head set 500 receives information transmission 31 from the first audio communication interface in the hardware interface 300. As stated above transmission 31 could be in the form of initially a ring followed by healthcare worker answering the ring or in another embodiment the patient treatment is audibly communicated via the PDA 500 headset. In addition to the audible instructions, other communications can be transmitted to the PDA including conformation of the treatments, query processing, questions and answers, graphic choices, and input queries by the healthcare worker. The PDA 500 can be used for any other data that may need to be given back to computer 200 automatically or as needed and may have any format that will be determined to work with the treatment including items such as patient vitals, blood pressure, pulse, respiration treatment completion and results or even a rejection of accepting the request for treatment.

During communication back between the central computer 200 and the PDA 500, the computer 200 can generate and send a query command to the PDA 500 along with audio communication. The query command represents a request for data, representing information, by the computer 200 from the PDA 500. This information can be responded to in one embodiment by an audio response by the worker into the headset of the PDA 500. Alternate standard methods of query response could be used instead of or in the alternative to the audio response. This could be important where the central computer 200 is having trouble with a long or complex answer or where input manually might be more effective or generally as a back-up to audio communication. Other capture alternatives can be included in other embodiments including use of bar-code scanning and Radio Frequency ID (RFID) scanning to capture responses such as patient and medication identification. Other methods of data capture include text or GUI. What additional data capture alternatives are used will depend on the system implemented and on the nature of either the response required or the number of other alternatives desired.

PDA 500 can communicate 32 back to the central computer via the hardware interface 300 using a second communication interface. The second communication interface for receiving the response of the worker is designed to receive communication from the worker in what ever manner the system is set up to allow the worker to use during transmission of information to computer 200. In one embodiment, the information is received in an audio manner from the PDA 500. Healthcare worker could respond to queries by answering a yes/no question, picking from a series of numbered responses or just speaking a response depending on what type of input the query is asking for.

Once the second communication interface in the hardware interface 300 receives the query response via the communication channel 32, the computer 200 will need to process 20 the information back from audio input or other format using voice recognition software or other appropriate software. The processing is so that the data is transformed into appropriate digital data for computer 200 to further process, sort, distribute, or the like the data received from the PDA 500 which was received via the communication channel 32 to the second communication interface in the hardware 300. In one embodiment the digital format of a voice response will be displayed on the handheld computer screen or other screen in the system for verification purposes.

At this point, computer 200 has several things it can do with the data to further process data and information, make decision and manage point-of care of the patient or of the medical process in general. The computer 200 can further validate format and dependency check the response or data 21. It can also process the data and record actions 22 such as medication administration, therapy completion, diagnostics and the like. From there, recorded information can be further processed, for example, any request 24 from the healthcare worker can be fed back to the patient needs processing loop 12-15 for further queries or treatment input to the worker. It can also perform task progress recording 25. It can further continue to process information and eventually feed back information and data 108 to the original data input sources 101 via an integration adaptor 26 utilizing, in one embodiment, the health care industry standard.

The central computer 200 can also process other information and make other processes part of the management system 100. For example, it can issue and control alerts 201 automatically generated from the system based on incomplete task or the like or from the organization to the workers. It can also manage errors such as end-user errors 202 and interface data errors 203. One useful function of the management system 100 is that the computer 200 can produce performance monitoring using the dashboard concept and measurement and reporting 204 with the data processed in the system 100.

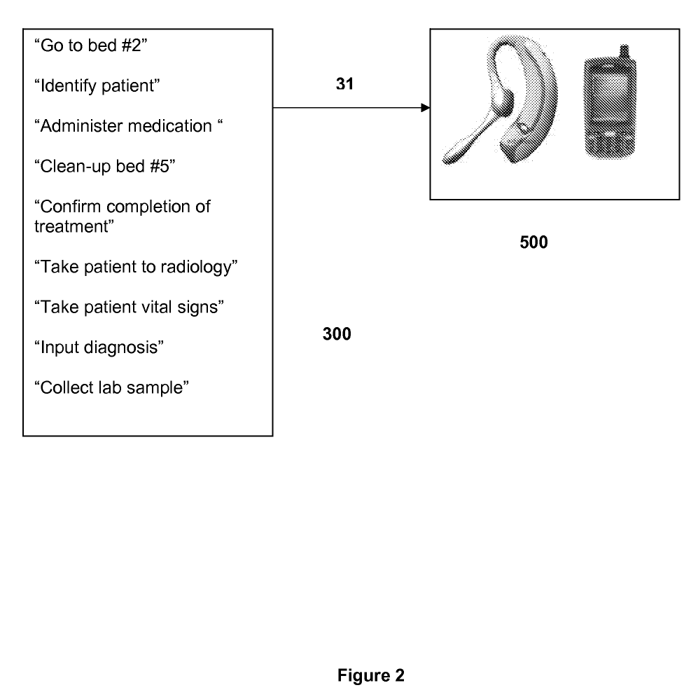

FIG. 2 displays a small piece of the management system 100 depicted in FIG. 1. In this figure hardware interface 300 is shown to have generated a list of patient treatment commands which are communicated 31 wirelessly to a PDA with wireless headset 500. Obviously, other commands could be communicated and replies to queries could also be communicated in return as described above. It is important to note that not only medical treatment is included but other functional activities such as clean-up identify patient and just to confirm completion of the communicated instruction.

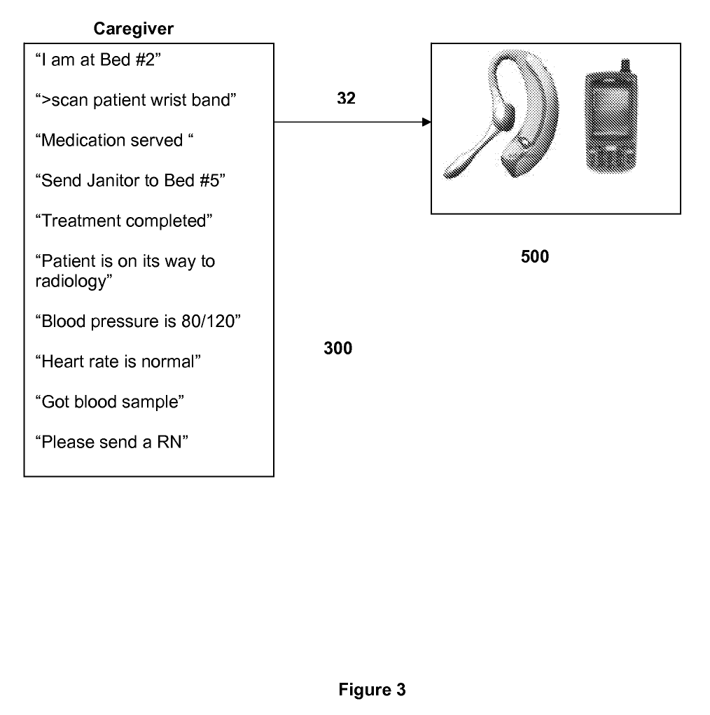

FIG. 3 displays another small piece of the management system 100 in FIG. 1. In this figure, healthcare worker has generated responses and information which is communicated 32 by voice to a PDA with wireless headset 500. Once again this is an exemplary list of commands for illustration only. It is important to note that input from the healthcare worker can take many forms as well from input of data to status and the like.

Examples and the explanations herein are intended to be illustrative of the present invention and not to be construed as limiting in any manner. The invention is defined by the following claims with equivalents to each claim and part of the claim intended to be included therein.

What I claim is:

1. A point-of-care system for delivering systematic patient treatment by one or more healthcare workers wherein each healthcare worker is assigned to providing treatment to a selected one or more patients comprising:
a. one or more wireless handheld computers capable of receiving audio communication wherein each of said handheld computers is designed to be assigned to an individual healthcare worker;
b. a text to speech system; and
c. a central computer system capable of acquiring data or processing data for patient treatment parameters, and the healthcare worker assigned to administer the treatment;
d. the central computer having a first audio communication interface for communicating patient treatment parameters at a selected time with a selected computer from step a) corresponding to the healthcare worker assigned to administer the treatment parameters being communicated, and a second communication interface for receiving to the response from the healthcare worker to the communicated treatment parameters.

2. A system according to claim 1 which further comprises a voice recognition system and the handheld computer is capable of sending audio communication.

3. A system according to claim 1 wherein the hand-held computer is a PDA with one or more capabilities selected from the group consisting of audio headset, bar-code reader, radio frequency ID reader and graphic user interface.

4. A system according to claim 1 which further comprises a process for the central computer to determine the time for administration of treatment.

5. A system according to claim 1 which further comprises an alert system.

6. A system according to claim 1 which further comprises a query system.

7. A system according to claim 1 wherein the processing is selected from one or more of the group consisting of assigning, dispatching, planning, optimizing, scheduling, prioritizing, validating, formatting and dependency checking.

8. A system according to claim 1 wherein a single hardware interface controls both the first and second communication interface.

9. A system according to claim 1 wherein patient treatment parameters are communicated in a priority sequence.

10. A method of operating an audio based wireless point of care patient treatment system comprising:
a. acquiring data on a central computer system representing patient treatment parameters; and then processing the data such that it is prepared for audio presentation to a selected healthcare worker on a wireless handheld computer;
b. transmitting the patient treatment parameters from the central computer to the handheld computer at a selected time, such that it is presented in an audio manner to the selected healthcare worker;
c. acquiring digital data on the central computer from the selected healthcare worker regarding the patient treatment parameters.

11. A method according to claim 10 which further comprises a voice recognition system and the handheld computer is capable of sending audio communication.

12. A method according to claim 10 wherein the hand-held computer is a PDA with a head set.

13. A method according to claim 10 which further comprises a process for the central computer to determine the time for administration of treatment.

14. A method according to claim 10 which further comprises an alert system.

15. A method according to claim 10 which further comprises a query system.

16. A method according to claim 10 wherein the processing is selected from one or more of the group consisting of assigning, dispatching, planning, optimizing, scheduling, prioritizing, validating, formatting and dependency checking.

17. A method according to claim 10 wherein a single hardware interface controls both the first and second communication interface.
